(19) United States
(12) Patent Application Publication
(10) Pub. No.: US 2018/0235839 A1
(43) Pub. Date: Aug. 23, 2018

(54) Dual Container for Sterile Fabrication and Filling

(71) Applicant: Leonidas A. Johnson, Diamond Bar, CA (US)

(72) Inventor: Leonidas A. Johnson, Diamond Bar, CA (US)

(21) Appl. No.: 15/900,237

(22) Filed: Feb. 20, 2018

Related U.S. Application Data
(60) Provisional application No. 62/460,255, filed on Feb. 17, 2017.

(51) Int. Cl. A61J 1/20; A61J 1/14; B29C 49/42; B29C 49/70; B29C 49/48; B65B 3/00; B65B 3/02

(52) U.S. Cl. CPC A61J 1/2089; A61J 1/1431; B29C 49/4273; A61J 1/06; B29C 49/48; B65B 3/003; B65B 3/02; B29C 49/70

(57) ABSTRACT

A multi-reservoir dispensing, disposable and sterile container has at least two separate and distinct reservoirs positioned adjacent to one another, and which can be readily manufactured using blow-fill-seal technology. The reservoirs contain components of a mixed pharmaceutical formulation, which is prepared at the time of dispensing from the container by blending of the contents of the reservoirs. Liquid flow channels extend from each reservoir and merge together at or near an exit aperture of the container, and a mixing feature can be employed at or downstream of the point of merging. In the container as provided to a user the exit aperture is blocked by a seal, which is removed prior to dispensing.

This application claims priority to U.S. provisional application having Ser. No. 62/460,255 filed on Feb. 17, 2017. This and all other extrinsic materials discussed herein are incorporated by reference in their entirety. Where a definition or use of a term in a reference that is incorporated by reference is inconsistent or contrary to the definition of that term provided herein, the definition of that term provided herein applies and the definition of that term in the reference does not apply.

### FIELD OF THE INVENTION

The field of the invention is dispensing disposable liquid containers, particularly dual containers.

### BACKGROUND

The following description includes information that may be useful in understanding the present invention. It is not an admission that any of the information provided herein is prior art or relevant to the presently claimed invention, or that any publication specifically or implicitly referenced is prior art.

Blow-Fill-Seal (BFS) technology is a manufacturing technique used to produce small, (0.1 ml-99 ml) and large volume, (100 mL+) liquid-filled containers. Blow-fill-seal technology was originally developed in Europe in the 1930s, and was introduced in the United States in the 1960s by Rommelag. Over the last 20 years it has become more prevalent within the pharmaceutical industry and is now widely considered to be the superior form of aseptic processing of pharmaceutical and healthcare products by various medicine regulatory agencies including the U.S. Food and Drug Administration (FDA). The basic concept of the blow-fill-seal (BFS) and form-fill-seal (FFS) Technology is to reduce contamination by forming the container (for example, by blowing into a mold), then filling and sealing the formed container within a closed sterile chamber. These operations are generally all performed within the same machine. This process greatly reduces the chance of contamination during the manufacturing of sterile products, and can reduce or eliminate the need to include preservatives. Thus this technology can be used to aseptically manufacture sterile pharmaceutical liquid dosage forms.

Current processes generate simple single-reservoir containers, using a multi-step process. First, a pharmaceutical-grade plastic resin is vertically heat extruded through a circular throat to form a hanging tube called a parison. The parison is enclosed within a two-part mold designed to form the body of the container, and cut off above the mold. The mold with the enclosed portion of the parison is then transferred to a filling zone (or a sterile filling space) where a filling needle (e.g. a mandrel) is inserted through an exposed portion of the parison and used to inflate the plastic and form the container within the mold. Following the formation of the container, the mandrel is used to fill the container with the desired substance, generally a liquid or a flowing powder. After filling the mandrel is retracted and a secondary top mold applied to seal or form a sealing structure for the container. These steps take place inside of a sterile chamber, and produce a sterile product. The product is then discharged to a non-sterile area for labeling, packaging and distribution. Current processes, however, are limited to generating a container that provides only a single product, or at best a series of containers that provide single products that are dispensed individually.

A disposable container which allows us to dispense a unit dose of sterile liquid medications is particularly useful for persons who need to take medication on a daily basis, as there is no large volume stock of medication to become contaminated and the need for accurate measurement is reduced. In addition the contents of such disposable containers may not require the addition of preservatives, which many people are sensitive to.

There are instances in the prior art describing single liquid containers for this purpose, for example in U.S. Pat. No. 3,358,062, to Burkett et al. (filed Jun. 6, 1965). All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. In this patent, the taught method uses BFS technology to generate a container that provides a single product, or at best a series of containers that each provide a single product that is dispensed individually. The resulting container(s) cannot provide dispensing of two different types of liquids at the same time.

United States Patent Application Publication No. 2007/0187429, to Fioretto (filed Feb. 15, 2006) describes a dual container where one container is attached to one end of a second container, essentially connected back to back. However, the described containers are not sterile, and it is not clear that they can be manufactured using sterile filling conditions. It is not apparent that such these containers can safely contain a product that requires sterility.

Thus, there is still a need for a dual container that can be both readily manufactured and filled in a sterile environment and that provides for storage and dispensing of at least two substances.

### SUMMARY OF THE INVENTION

The inventive subject matter provides apparatus and methods for a multi dispensing, disposable and sterile container. The multi container has two or more physically separated reservoir, which can be connected by channels. For example, two liquids are stored in two separated reservoirs, one is an aqueous buffer with water-soluble compounds and the other is oil with oil-soluble compounds. In addition, the multi container can be held all reservoirs together on the top of each other along seal. As a result, a person can be easily consume multiple substances together at once by providing pressure on the top of reservoirs.

The size of the aperture in one channel connected to a reservoir can be the same or greater than that in the other reservoir connected to the other reservoir. For example, an aperture size can be adjusted to provide consistent flow rates between reservoirs that contain liquids having different viscosities or other rheological characteristics.

In some embodiments, liquid channels extended from reservoirs are completely separated. In some embodiments, zigzag liquid channels are extended from reservoirs and merged together downstream of the zigzag channels, such that two liquids from two separated reservoirs are not mixed easily in the presence of zigzag channels. In addition, two liquids can be mixed together under sterile conditions by compression onto the reservoirs prior to consumption of substances. In some embodiments, regarding a container that include three or more reservoirs, the channels extended from more than one reservoir can be merged together, such that at least two contents are mixed together prior to mixing one or more contents from other reservoirs.

### BRIEF DESCRIPTION OF THE DRAWINGS

FIG. 1 is a cross sectional view of a dual reservoir container or dispenser of the inventive concept.

FIG. 2 depicts a container or dispenser of the inventive concept having three reservoirs.

FIG. 3 depicts container or dispenser of the inventive concept that incorporates a mixing feature.

FIG. 4 depicts an alternative container or dispenser of the inventive concept that incorporates multiple mixing features.

### DETAILED DESCRIPTION

Various objects, features, aspects and advantages of the inventive subject matter will become more apparent from the following detailed description of preferred embodiments, along with the accompanying drawing figures in which like numerals represent like components.

The inventive subject matter provides apparatus and methods for a multi sterile container which is capable of dispensing and being disposable. The multi container has two or more physically separated reservoirs, which join in common flow path to dispense to different fluid contents of the reservoirs simultaneously. Such a multi container can include one or more mixing regions along such a flow path and/or at a juncture of flow paths from individual reservoirs in order to enhance mixing. In some embodiments the diameter of a flow path and/or the size of an aperture in fluid communication with a reservoir can be dimensioned to control the rate of fluid flow along the flow path, for example to provide for proportionate mixing of the contents of one fluid reservoir with another upon dispensing. Multi containers of the inventive concept can be manufactured and filled using blow-fill-seal and/or form-fill-seal technologies to provide a single device presenting two or more different sterile contents. Such a device permits separate storage of stable (e.g. stable for at least 6 months or more at ambient temperature, stable for at least 6 months at 2° C. to 8° C.) precursors to an active formulation formed on mixing of the stable precursors, where the active formulation is itself unstable (e.g. degrades or otherwise becomes unusable within 6 months or less at ambient temperature, degrades or otherwise becomes unusable within 6 months or less at 2° C. to 8° C.).

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

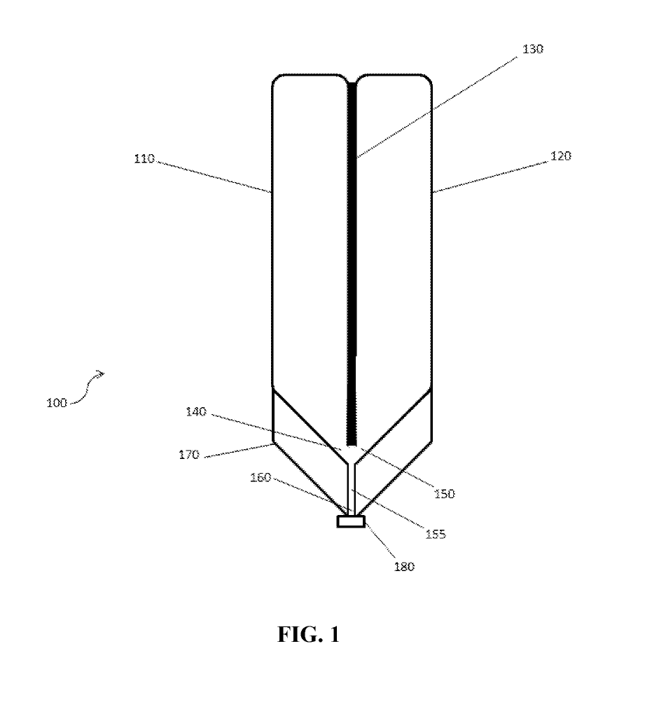

FIG. 1 generally illustrates an example of one embodiment of the invention. FIG. 1 shows a dual container 100 that includes a first and a second reservoir (110 and 120, respectively) separated by a sealing feature 130. Alternatively, the reservoirs can be essentially independent, but coupled to one another at one or more points (for example at one or both ends). First and second liquid channels (140 and 150, respectively) can be connected from these first and second reservoirs 110 and 120. In some embodiments such channels can be relatively short (e.g. essentially apertures); in other embodiments such channels can extend as lumens, channels, and/or passages from the reservoirs. On dispensing, liquids from the reservoirs 110, 120 exit the dispensing device via an exit aperture 160. In some embodiments, channels 140, 150 from the reservoirs 110,120 can merge into a common dispensing channel 155 positioned upstream from the exit aperture 160. Such an exit aperture 160 can be blocked or sealed by a sealing feature 180 that is removed (for example, by twisting, cutting, or tearing) immediately prior to use to open or expose the exit aperture 160. In some embodiments, an end of either or both of the first 140 and second 150 liquid channels can be sealed, such that liquid in the first reservoir 110 is partially or completely separated from liquid in the second reservoir 120. In some embodiments the first and second reservoirs 110, 120 and/or associated channels can be coupled to a common backing or sheet 170, which can serve to protect and properly position the reservoirs for dispensing. In some embodiments the common backing or sheet 170 is limited to a portion (for example, a dispensing end) of the reservoirs 110, 120. In other embodiments a common backing or sheet 170 extends around all or a portion of lateral and/or terminal (i.e. non-dispensing) walls of the reservoirs 110, 120. In other embodiments the reservoirs 110, 120 are essentially independent with the exception of one or more attachment points (i.e. able to move independently except where coupled to one another). Although shown with two reservoirs, the Inventor contemplates that dispensers of the inventive concept can include 3, 4, or more reservoirs, each of which can include different contents.

As noted above, the exit aperture 160 can be blocked or sealed by a sealing device 180 or feature that is removed or disrupted prior to use. Such a sealing feature can be a simple heat seal imprinted at or near the exit aperture 160. Such a heat seal can be continuous or discontinuous (e.g. ‘stitched.). In some embodiments the sealing device can include a cap, tab, or similar device to facilitate removal. In a preferred embodiment the dispensing device is configured such that in use a user holds both reservoirs on the top of each other with the sealing device at the bottom, such that to the user can easily remove the sealing device and dispense the two liquids together at once by manual compression of one or more reservoirs.

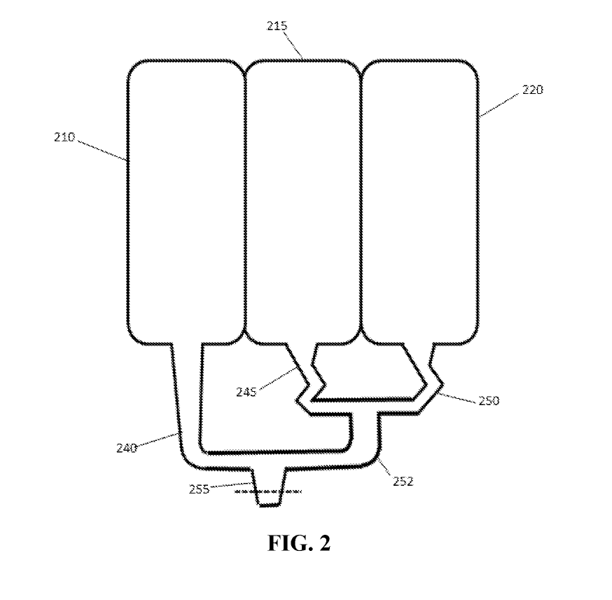

As shown in FIG. 2 some embodiments of the inventive concept the dispenser can include three or more reservoirs 210, 215, 220, at least two of which can include different flowable materials (e.g. powders, liquids, gels, foams, etc.). In such embodiments channels in fluid communication with each of the reservoirs can merge together prior to or at the exit aperture. In some embodiments fluid channels from a subset (i.e. some but not all) of the reservoirs can be merged together prior to joining the contents of the remaining reservoirs, such that the contents of that subset of reservoirs are mixed together prior to mixing one or more contents from other reservoirs. As shown in FIG. 2, a flow channel 245 from one reservoir 215 can join with a flow channel 250 from a second reservoir 220 to form a secondary channel 252 where the contents of these reservoirs are mixed before joining with a flow channel 240 from a third reservoir 210. The contents of all reservoirs are mixed in a common flow channel 255 on use of the device. For example, in a dispenser having three reservoirs, contents of a reservoir containing an aqueous solution can be mixed with the contents of a reservoir containing a surfactant by merging of fluid channels connected to these reservoirs at a point upstream from the merging of a fluid channel in communication with a reservoir containing an oil or similar organic fluid. Such staged mixing of the contents of different reservoirs of a dispenser of the inventive concept can facilitate mixing of contents and/or the formation of emulsions or suspensions upon mixing.

Such a “dual container” can be manufactured using blow-fill-seal technology. In some embodiments the reservoirs and channels can be molded and the sealing feature between the reservoirs readily deformed by manual pressure. Each reservoir can be completely or partially separated, such that each reservoir encloses a different composition and/or liquid. This arrangement advantageously permits individual optimization and stabilization of otherwise potentially incompatible liquid compositions.

In a preferred embodiment, the composition of a flowable material in one reservoir can be different from that of a flowable material stored in a different reservoir of the same dispensing device. Examples of suitable flowable materials include liquids (e.g. solutions, suspensions, emulsions), powders, gels, foams, and non-Newtonian fluids that become flowable upon application of pressure. For example, the contents of one reservoir can include an aqueous buffer and one or more water-soluble compounds where the contents of another reservoir of the same dispensing device can include an oil and one or more oil-soluble compounds. Alternatively, the contents of one reservoir can include a first water-soluble compound and an aqueous buffer having a pH optimized for storage of the water-soluble compound, and where the contents of a second reservoir include a different water-soluble compound and a different aqueous buffer having a different pH. In addition, in some embodiments the dispenser can include three or more reservoirs that are connected next, allowing a user to store three or more different types of liquids such as aqueous solution at pH 7, aqueous solution at pH 10 and oil solution and mix them upon use.

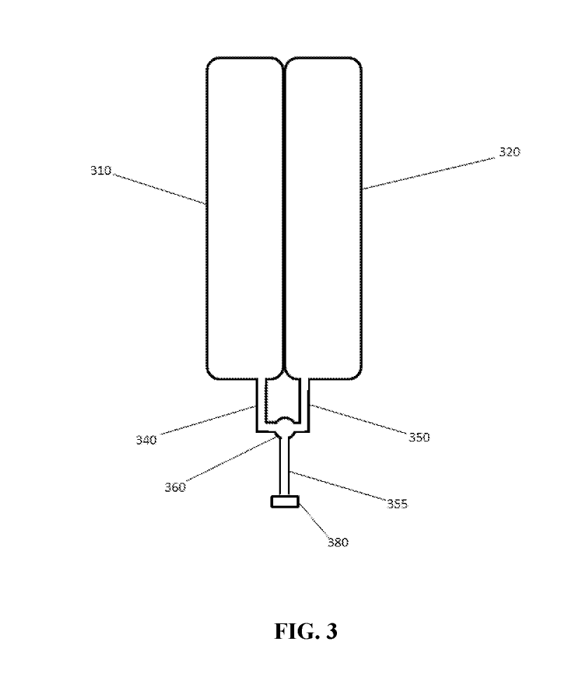

In some embodiments the reservoirs can include a mixing feature to facilitate thorough and consistent mixing of the contents of reservoirs upon dispensing. As shown in FIG. 3, in some embodiments flow channels 340, 350 in fluid communication with different reservoirs 310, 320 can join in a common mixing region or fixture 360 configured to facilitate mixing of the reservoir's contents. For example, a circular or spherical mixing feature can provide vortex flow that provides thorough and complete mixing prior to exiting through a common fluid channel 355 on use of the device. Such a common fluid channel 355 can terminate in a sealing feature 380 that is removed prior to dispensing.

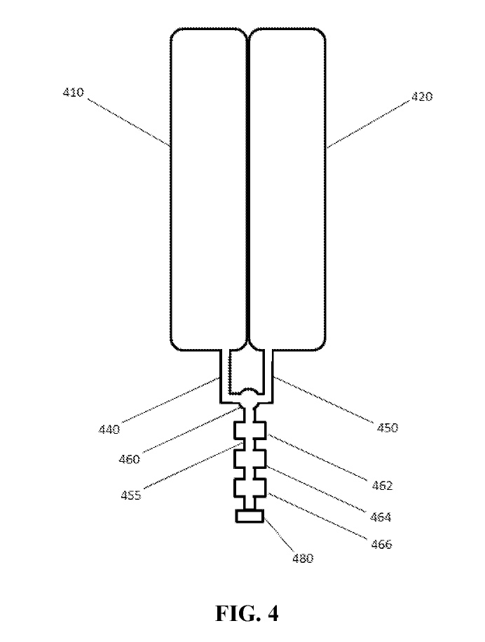

In some applications the contents of the reservoirs may require extensive mixing in order to provide the desired mixed product, for example for the delivery of an emulsion of mutually immiscible contents of the reservoirs. In such applications a dispenser of the inventive concept can include two or more mixing devices, some of which can be configured for mixing of reservoir contents and others for more vigorous agitation of the blended contents. An example of such an embodiment is shown in FIG. 4. As shown, flow channels 440, 450 from different reservoirs 410, 420 join at a primary mixing feature 460, which can be configured to provide basic mixing of reservoir contents. For example, primary mixing feature 460 can be configured as a sphere or with a circular cross section in order to facilitate vortex flow that provides thorough mixing. On leaving the primary mixing feature 460 the mixed reservoir contents pass through one or more secondary mixing features 462, 464, 466 arranged along the common fluid channel 455 that provide additional mixing and/or agitation of the mixed reservoir contents. Such a common fluid channel 455 can terminate in a sealing feature 480 that is removed prior to dispensing Such secondary mixing features can have a configuration similar to that of the primary mixing feature, or can have a different configuration (for example, edges, corners, or internal baffles/barriers that provide chaotic mixing).

Containers or dispenser of the inventive concept can be made of any suitable material, preferably a polymer that is suitable for blow-fill-seal manufacturing, is chemically resistant to the stored contents, and is pliable at the thicknesses used. Materials and wall thickness of a reservoir are preferably selected to be compressible or readily deformable by manual pressure applied by a person of average health. Suitable polymers include polyethylene, polypropylene, polyester, and/or silicone. In some embodiments the walls of the reservoirs can be of uniform thickness and relatively smooth, but pliable. In other embodiments the walls of a reservoir can be pleated or of an accordion-type, in order to apply greater pressure to reservoir contents and/or ensure more complete emptying of a reservoir that would be afforded by simple lateral compression. In some embodiments the reservoirs can be transparent or translucent. In other embodiments all or part of the dispenser or container can be opaque (for example, to permit storage of light-sensitive components). This can be achieved by incorporation of pigments into the polymer prior to molding or by post-molding treatment (for example painting or metallization). For example, the material used for molding of a reservoir can be water resistant, have low oxygen permeability, and/or be opaque to at least one of visible and ultraviolet light. Reservoir walls can range in thickness from about 50 μm to about 3 mm, and are preferably about 1.5 mm or less.

The contents of a reservoir can be any types of flowable material, such as an aqueous or organic liquid, a flowable powder, a gel, a cream, a foam, or a non-Newtonian fluid that becomes flowable upon application of pressure. Typical reservoir contents are formulated to produce products for medical use, including (but not limited to) pharmaceutical eye drops, oral liquid solutions, pharmaceutical creams, and adhesive materials (for example, epoxies for bone fixation, dental work, and/or wound closure) on-site at the time of use. In embodiments where the contents of a reservoir need to be activated prior to usage, an activator in a separate reservoir can be mixed with a precursor stored in the other reservoir and that requires activation. Activation then takes place on formation a mixture on dispensing, and the active mixture used immediately. The same strategy can be applied to a mixture, for example when a mixture is unstable over time. The container herein provides an immediate use of the mixture after mixing of at least two solutions.

In some embodiments a scale mark or similar visible indicia of volume can be included on one or more reservoirs of the dispensing device. This permits a user to dispense a desired portion of a reservoir's contents. Such an embodiment advantageously permits use of a container or dispenser to produce more than one dose. In such embodiments the sealing feature can be reusable, for example being threaded or dimensioned to provide a friction fit over or within a fluid channel exiting the dispenser.

The volume of each individual reservoir can range from about 50 μL to about 5 mL, preferably from about 100 μL to about 2 mL. It should be appreciated that all of the contents of a reservoir may not be dispensed upon use, and the volumes of the reservoirs adjusted appropriately. In a preferred embodiment, in a dual reservoir container the reservoirs can be sized to dispense about half amount of a desired single dose volume produced when reservoir contents are mixed together. For example, if a final volume of about 0.4 mL is desired, each reservoir can be dimensioned to deliver about 200 μL of liquid.

As noted above, on dispensing the stored liquids can exit their respective reservoirs via an aperture and/or channel associated with the reservoir. The shape of the aperture and/or channel can be preferably circular or elliptical. The diameter of such an aperture and/or channel connected to a first reservoir can be the same or greater than that in a different reservoir of the dispensing device and in fluid communication with the first reservoir. The length of a flow channel of a container or dispenser of the inventive concept can range from less than 2 mm to about 20 mm. In more preferred embodiments, the length can range from about 3 mm to about 10 mm. Apertures can range in size from about 100 μm to about 5 mm, and are preferably from about 200 μm to about 2 mm. In some embodiments, the size of apertures associated with different reservoirs can be different and selected to provide a desired mixing ratio between reservoir contents upon dispensing. For example, smaller apertures can be provided for reservoirs having contents that are intended to be minority components of a composite composition.

Another embodiment of the inventive concept is a method of treating a disease or condition by local application of a pharmaceutical mixture that is produced on-site at or immediately prior to application. In such an embodiment the pharmaceutical mixture can have insufficient stability to permit formulation as a single, uniform formulation. In such a method a container or dispenser as described above is provided that includes the components of the pharmaceutical mixture in different reservoirs, where they can be stored under stabilizing conditions. Upon opening and dispensing of the contents of the dispenser or container the functional pharmaceutical mixture is generated for immediate application. For example, a dispenser or container of the inventive concept can be used to generate an oil-in-water emulsion that provides a non-water soluble pharmaceutical agent in a suspension of a physiologically compatible aqueous buffer. Alternatively, a dispenser or container of the inventive concept can be provided that generates a micellar suspension of a pharmaceutically active components in a physiologically compatible buffer (for example, by addition of and subsequent vigorous mixing with a suitable surfactant). In still other embodiments one component of the pharmaceutical mixture can be provided as a stable but inactive precursor, which is activated by mixing with an activating compound stored in a different reservoir on dispensing.

As noted above, containers or dispensers of the inventive concept are formed using blow-fill-seal technology under sterile conditions. In an example of such a manufacturing method one or more parisons can be generated by the same or different mandrels, and placed in a mold assembly or portion thereof corresponding to a specific reservoir. In some embodiments a single parison is provided to mold assembly configured to generate two or more reservoirs upon further processing. In other embodiments two or more parisons are provided (for example, by independent mandrels) that each correspond to a reservoir upon further processing. Placement of the parison(s) within the mold assembly can leave one or more exposed neck(s) that provides access to the reservoir's interior. In some embodiments each parison has a neck. In other embodiments a single neck can service two or more parisons. Inflation through the neck(s) form individual reservoirs within the mold assembly. These reservoirs can then be filled via their respective necks with their respective flowable contents, using the same mandrel or different mandrels. Mixing of contents between the reservoirs during or after filling can be prevented by sealing a common fluid flow channel (thereby preventing flow through reservoir-associated flow channels) and or/by surface tension across an aperture that leads to a reservoir-associated flow channel.

A mold assembly utilized to form reservoirs can include components that provide for non-reservoir features, such as flow channels between the reservoirs, mixing chambers, and other features as detailed above. Alternately, a secondary mold assembly can be applied (for example, at least in part to a protruding neck) to provide for non-reservoir features, such as flow channels between reservoirs, mixing chamber, sealing features, etc. In some embodiments such molds or mold portions provide for contact points between the parisons that provide fixation of the reservoirs to each other in the final dispenser or container. After filling and sealing containers and/or dispensers of the inventive concept can be subjected to post-molding and filling processes, such as painting, metallization, and labeling. In some embodiments containers and/or dispensers of the inventive concept can include machine-readable indicia (for example, a bar code, and RFID chip, etc.) that provides manufacturing information such as production facility, production date, expiration date, and individual product identification.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A disposable multi-reservoir container, comprising:
a first reservoir comprising a first lateral wall and first flowable contents;
a second reservoir comprising a second lateral wall and second flowable contents;
a first flow channel in fluid communication with the first reservoir and a second flow channel in fluid communication with the second reservoir;
an exit aperture in fluid communication with both the first flow channel and the second flow channel; and
a removable sealing feature positioned to block flow through the exit aperture,
wherein first lateral wall and the second lateral are juxtaposed with one another, the first flowable contents and the second flowable contents are different from each other, and wherein the first reservoir, second reservoir, first flowable contents, and second flowable contents are sterile.

2. The disposable multi-reservoir container of claim 1, wherein the first reservoir and second reservoir comprise a polymer selected from the group consisting of polyethylene, polypropylene, polyester, and silicone.

3. The disposable multi-reservoir container of claim 1, wherein the disposable multi-reservoir container are produced and filled in a common machine by blow-fill-seal (BFS) technology.

4. The disposable multi-reservoir container of claim 1, wherein the internal volume of the first reservoir and the second reservoir are each between 100 μL and 2 mL.

5. The disposable multi-reservoir container of claim 1, wherein the first flow channel and the second flow channel merge together prior to the exit aperture.

6. The disposable multi-reservoir container of claim 1, wherein the first reservoir comprises visual indicia related to fill volume of the first reservoir.

7. The disposable multi-reservoir container of claim 1, wherein the first flowable content includes an active agent provided in a media selected from the group consisting of an aqueous solution, an organic solvent, a flowable powder, a gel, a foam, a cream, a suspension, and an emulsion.

8. A method of treating a disease or condition using a pharmaceutical mixture, comprising:
providing a disposable multi-reservoir container comprising a first reservoir comprising a first lateral wall and first flowable contents, a second reservoir comprising a second lateral wall and second flowable contents, a first flow channel in fluid communication with the first reservoir and a second flow channel in fluid communication with the second reservoir, an exit aperture in fluid communication with both the first flow channel and the second flow channel, and a removable sealing feature positioned to block flow through the exit aperture, wherein first lateral wall and the second lateral are juxtaposed with one another, the first flowable contents and the second flowable contents are different from each other, and wherein the first reservoir, second reservoir, first flowable contents, and second flowable contents are sterile;
removing the sealing feature; and
compressing at least one of the first lateral wall and the second lateral wall to induce flow of the first flowable contents through the first flow channel and flow of the second flowable contents through the second flow channel, thereby dispensing an active pharmaceutical mixture comprising a mixture of a first pharmaceutical component and a second pharmaceutical component through the exit aperture,
wherein the first flowable contents comprise the first pharmaceutical component and the second flowable contents comprise the second pharmaceutical component.

9. The method of claim 8, comprising the additional step of applying the pharmaceutical mixture to a site in need of treatment.

10. The method of claim 8, wherein the first flowable contents and second flowable contents are stable on storage at ambient temperature for a period of at least 6 months, and wherein the active pharmaceutical mixture is not stable at ambient temperature for a period of at least 6 months.

11. The method of claim 8, wherein the first flowable contents and second flowable contents are stable on storage at 2° C. to 8° C. for a period of at least 6 months, and wherein the active pharmaceutical mixture is not stable at 2° C. to 8° C. for a period of at least 6 months.

12. The method of claim 8, wherein the active pharmaceutical mixture comprises an emulsion or a suspension.

13. The method of claim 8, wherein at least one of the first flowable contents and the second flowable contents comprises an organic solvent.

14. The method of claim 8, wherein the first reservoir comprises visual indicia related to volume of the first reservoir, and further comprising the step of utilizing the visual indicia to dispense a partial volume from the first reservoir that is appropriate for a single unit dose of the active pharmaceutical mixture.

15. A method of manufacturing a multi-reservoir container, comprising:
forming a first parison and a second parison within a blow-fill-seal device using the same or different mandrels;
providing a primary mold assembly comprising a first reservoir forming portion and a second reservoir forming portion;
placing the first parison in the first reservoir forming portion and the second parison in the second reservoir forming portion;
inflating the first parison to form the first reservoir and inflating the second parison to form the second reservoir;
dispensing a first flowable content to the first reservoir;
dispensing a second flowable content to the second reservoir;
sealing the first reservoir and the second reservoir; and
releasing the multi-reservoir container from the mold,
wherein the first flowable content comprises a first portion of ingredients of an active pharmaceutical mixture and the second flowable content comprises a second portion of ingredients of the active pharmaceutical mixture, and wherein molding, filling, and sealing operations take place under sterile conditions in a common machine.

16. The method of claim 15, wherein the steps of inflating and filling the first reservoir and the second reservoir take place through a common neck.

17. The method of claim 15, wherein the steps of inflating and filling the first reservoir take place through a first neck and the steps of inflating and filling the second reservoir take place through a second neck, wherein the first neck and the second neck are distinct.

18. The method of claim 15, wherein the primary mold assembly comprises a first flow channel molding portion configured to provide a first flow channel in fluid communication with the first reservoir and a second flow channel molding portion configured to provide a second flow channel in fluid communication with the second reservoir of the multi-reservoir container.

19. The method of claim 18, where one of the primary mold assembly comprises at least a portion of a mixing region mold portion, wherein the mixing region mold portion is configured to provide a mixing region at a junction of the first flow channel and the second flow channel in the multi-reservoir container.

20. The method of claim 15, further comprising the step of applying a secondary mold assembly to at least a portion of a neck of the first parison, wherein the secondary mold assembly comprises a first flow channel molding portion configured to provide a first flow channel in fluid communication with the first reservoir.

21. The method of claim 9, further comprising the step of applying the secondary mold assembly to at least a portion of a neck the second parison, wherein the secondary mold assembly comprises a second flow channel molding portion configured to provide a second flow channel in fluid communication with the second reservoir of the multi-reservoir container.

22. The method of claim 20, wherein the secondary mold assembly further comprises a mixing region mold portion, wherein the mixing region mold portion is configured to provide a mixing region at or downstream of a junction of the first flow channel and a second flow channel in the multi-reservoir container.
